(19) United States
(12) Patent Application Publication
(10) Pub. No.: US 2010/0202370 A1
(43) Pub. Date: Aug. 12, 2010

(54) METHOD FOR SELECTING MODULATION AND CODING SCHEME FOR MULTI-ANTENNA SYSTEM

(75) Inventors: YEN CHIN LIAO, HSINCHU COUNTY (TW); YUNG SZU TU, HSINCHU COUNTY (TW); CHUN HSIEN WEN, HSINCHU COUNTY (TW); JIUNN TSAIR CHEN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/486,555

(22) Filed: Jun. 17, 2009

(30) Foreign Application Priority Data
Feb. 12, 2009 (TW) 098104422

(51) Int. Cl. H04W 72/04

(52) U.S. Cl. 370/329

(57) ABSTRACT

A method for selecting modulation and coding scheme (MCS) for multi-antenna systems comprises the steps of: a multi-antenna system transmits signals according to MCSs of single spatial stream and determines an MCS accordingly. Subsequently, the multi-antenna system increases the number of the spatial streams applied, transmits signals according to the corresponding MCSs and determines an MCS accordingly until an optimum MCS is found.

### BACKGROUND OF THE INVENTION

1. Field of the Invention

The present invention relates to a method for selecting modulation and coding schemes for a communication system, and more particularly, to a method for selecting modulation and coding schemes for a multi-antenna system.

2. Description of the Related Art

In Wi-Fi wireless local area networks, such as those following the IEEE 802.11in standard, a receiver is required to suggest a transmitter the modulation and coding scheme (MCS) based on transmission environment, and the MCS adopted by the transmitter is adjusted with the variation of the transmission environment so as to maintain the highest transmission throughput.

Automatic rate fallback (ARF) algorithm is a popular MCS selection technique. It establishes a priority order for every MCS for the applied communication system, and calculates the packet error rate (PER) for a fixed amount of time in the receiver. If, within a fixed amount of time, the PER in the receiver exceeds an upper threshold, an MCS with lower data rate is adopted according to the priority order. If, in the fixed amount of time, the PER in the receiver drops below a lower threshold, another MCS with higher data rate is adopted according to the priority order. Since the ARF algorithm needs to calculate the PER within a fixed amount of time for every MCS adjustment, a lot amount of time is spent on lesser MCSs, which affects the throughput of the communication system. In addition, for a multi-antenna system, the real data rates provided by every MCS depend on the signal to noise ratio (SNR) of each antenna, and therefore the priority order cannot be established based on data rates for single-antenna systems. An ill-established priority order can cause the communication system to be unable to select the optimum MCS.

Another MCS selection method is based on the transmission environment, that is, adjusting the MCS for the transmitter based on the SNR. FIG. 1 shows experiment results of the optimum MCSs for different SNRs in a wireless communication system complying with IEEE 802.11in standard. As shown in FIG. 1, the system structure is a double antenna system, wherein a double transmission antenna and a double receiving antenna are included. There are 16 MCSs available, wherein number 0 to number 7 are single spatial stream MCSs, and number 8 to number 15 are double spatial stream MCSs. The receiver stores the experiment results shown in FIG. 1 in a table and adjusts the MCS adopted by the transmitter according to the stored experiment results. One drawback of this method is that the accuracy of the estimated SNR affects the performance of the communication system. In addition, this table requires an excessively large storage space of the receiver such that the hardware cost increases significantly. Furthermore, if a triple antenna system or a system structure with more antennas is used, the required storage space would increase exponentially such that the hardware limitations could be prohibitive.

Therefore, there is a need to design a method for selecting MCS for multi-antenna systems that is fast and easy to implement.

### SUMMARY OF THE INVENTION

The method for selecting modulation and coding schemes of the present invention transmits signal based on MCSs of single spatial stream signals and increments the dimension of the single spatial stream signals until an optimum MCS is found.

The method for selecting modulation and coding schemes according to one embodiment of the present invention comprises the steps of: setting the dimension of transmission spatial stream signals of a multi-antenna system to 1 and transmitting signals based on different MCSs to determine an initial MCS; repeating incrementing the dimension of the transmission spatial stream signals by 1 and transmitting signals based on different MCSs to update the MCS of the multi-antenna system until the updated MCS is equal to the MCS before update or the dimension of the transmission spatial stream signals reaches a threshold; selecting the MCS before update as the MCS of the multi-antenna system if the updated MCS is equal to the MCS before update; and selecting the updated MCS as the MCS of the multi-antenna system if the dimension of the transmission spatial stream signals reaches a threshold.

The method for selecting modulation and coding schemes according to another embodiment of the present invention comprises the steps of: setting the dimension of transmission spatial stream signals of a multi-antenna system to 1 and transmitting signals based on different MCSs to determine an initial MCS; repeating incrementing the dimension of the transmission spatial stream signals by 1 and transmitting signals based on different MCSs to update the MCS of the multi-antenna system until the data rate of the multi-antenna system is smaller than that of the multi-antenna system before update or the dimension of the transmission spatial stream signals reaches a threshold; selecting the MCS before update as the MCS of the multi-antenna system if the data rate of the multi-antenna system is smaller than that of the multi-antenna system before update; and selecting the updated MCS as the MCS of the multi-antenna system if the data rate of the multi-antenna system is greater than that of the multi-antenna system before update and the dimension of the transmission spatial stream signals reaches a threshold.

### BRIEF DESCRIPTION OF THE DRAWINGS

The objectives and advantages of the present invention will become apparent upon reading the following description and upon referring to the accompanying drawings of which:

FIG. 1 shows experiment results of the optimum MCSs for different SNRs;

FIG. 2 shows the flow chart of a method for selecting MCSs for multi-antenna systems according to an embodiment of the present invention;

FIG. 3 shows a double antenna system;

FIG. 4 shows the corresponding data rates of a plurality of MCSs according to an embodiment of the present invention; and

FIG. 5 shows the available MCSs under selection according to an embodiment of the present invention

### DETAILED DESCRIPTION OF THE INVENTION

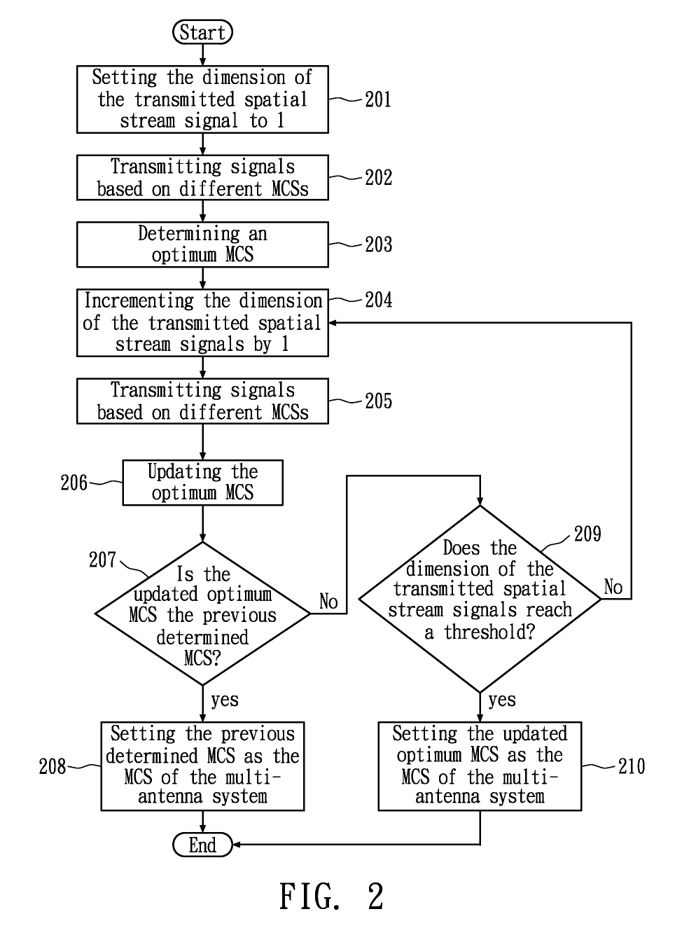

FIG. 2 shows the flow chart of a method for selecting MCSs for multi-antenna systems according to an embodiment of the present invention. In step 201, the dimension of the transmission spatial stream signals of a multi-antenna system is set to 1, and step 202 is executed. In step 202, signals of different MCSs are transmitted by the multi-antenna system, and step 203 is executed. In step 203, an optimum MCS is determined from the applied MCSs in step 201 according to the quality of the transmitted signals at the receiver, and step 204 is executed. In the present embodiment, the optimum MCS is the MCS with the highest data rate. In step 204, the dimension of the transmission spatial stream signals is incremented by 1, and step 205 is executed. In step 205, signals of different MCSs are transmitted by the multi-antenna system according to the updated spatial stream signals, and step 206 is executed. In step 206, an optimum MCS is determined from the applied MCSs in step 205 and the previous determined MCS according to the quality of the transmitted signals at the receiver, and step 207 is executed. In step 207, whether the updated optimum MCS is the previous determined MCS is checked. If the result is positive, step 208 is executed; otherwise, step 209 is executed. In step 208, the previous determined MCS is set as the MCS of the multi-antenna system, and the selecting method is finished. In step 209, whether the dimension of the transmission spatial stream signals reaches a threshold, e.g. the maximum dimension the multi-antenna system can provide, is checked. If the result is positive, step 204 is executed; otherwise, step 210 is executed. In step 210, the updated MCS is set as the MCS of the multi-antenna system, and the selecting method is finished.

In another embodiment of the present invention, in step 206, the optimum MCS is determined only from the applied MCSs in step 205, and therefore the updated optimum MCS is not the same as the previous determined MCS. Therefore, the check condition in step 207 can be revised to determine whether the data rate of the multi-antenna system is lower than that of the multi-antenna system before update. If the result is positive, step 208 is executed; otherwise, step 209 is executed.

In one embodiment of the present invention, in step 202, signals are transmitted by the multi-antenna system with all MCSs of single spatial stream signals. In another embodiment of the present invention, in step 205, signals are transmitted by the multi-antenna system according to all MCSs of the updated spatial stream signals. In yet another embodiment of the present invention, in step 205, signals are transmitted by the multi-antenna system according to a part of MCSs of the updated spatial stream signals. For example, if the data rate of the determined MCS in steps 203 or 206 is R, in step 205, under the updated spatial stream signals, the MCSs of the transmitted signals can be selected such that the data rates of the transmitted signal are between R and a x R, wherein a is a positive integer. For another example, if the determined MCS in steps 203 or 206 is MCSₖ, in step 205, under the updated spatial stream signals, the MCSs of the transmitted signals can be derived from the previous MCSₖ according to experiment data.

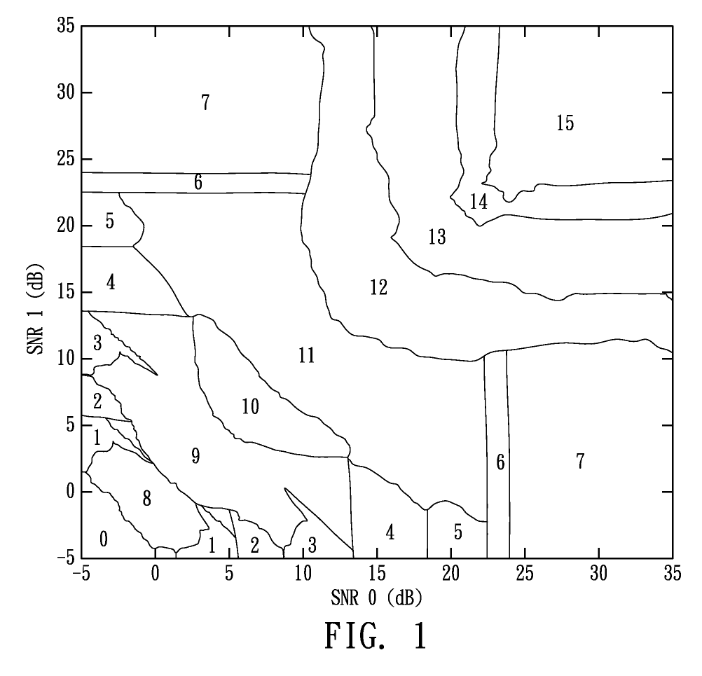

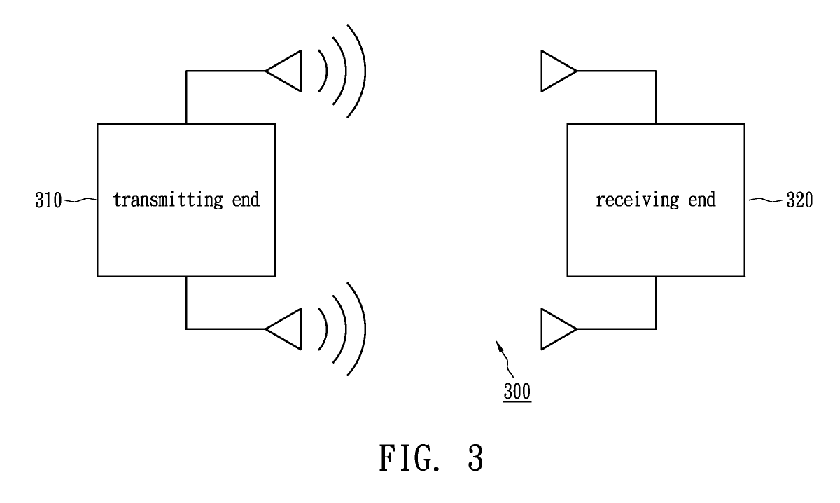

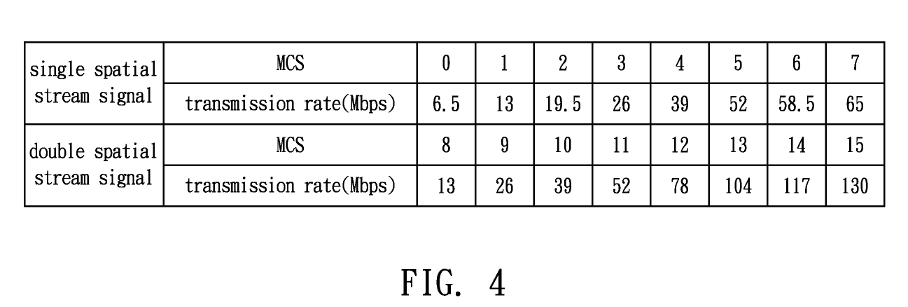

FIG. 3 shows a double antenna system 300, comprising a transmitting end 310 and a receiving end 320. The double antenna system 300 uses the method shown in FIG. 2 to select the applied MCS. The double antenna system 300 is implemented based on the IEEE 802.11in wireless communication network standard, and comprises MCS0 to MCS15, a total of 16 MCSs, wherein MCS0 to MCS7 are single spatial stream MCSs, and MCS8 to MCS15 are double spatial stream MCSs. FIG. 1 shows the experiment results of the double antenna system 300 of the optimum MCSs for different SNRs. FIG. 4 shows the data rates for every MCS of the double antenna system 300.

Following step 201, the dimension of the transmission spatial stream signals of the double antenna system 300 is set to 1. Following step 202, signals of different MCSs are transmitted by the double antenna system 300. In one embodiment of the present invention, signals are transmitted by the double antenna system 300 with all MCSs of single spatial stream signals, i.e., MCS0 to MCS7. Following step 203, the double antenna system 300 compares MCS0 to MCS7 according to the quality of the transmitted signals at the receiver and determined MCS5 as the optimum MCS, wherein the data rate of MCS5 is 52 Mbps as shown in FIG. 4. Following step 204, the dimension of the transmission spatial stream signals of the double antenna system 300 is incremented by 1 to be 2. Following step 205, signals of different MCSs are transmitted by the double antenna system 300 according to the updated spatial stream signals, i.e., double spatial stream signals. In one embodiment of the present invention, signals are transmitted by the double antenna system 300 according to all MCSs of the updated spatial stream signals, i.e., MCS8 to MCS15. In yet another embodiment of the present invention, the MCSs of the transmitted signals are selected from the double spatial MCSs such that the data rates of the transmitted signal are between R and a×R, wherein if a is 3, the selected MCSs are MCS11, MCS12, MCS13, MCS14 and MCS15. In yet another embodiment of the present invention, MCS11, MCS12, MCS13 and MCS14 are the derived MCSs from MCS5 according to the experiment results shown in FIG. 1 and are thus selected as the MCSs of the transmitted signals. Following step 206, from the applied MCSs in step 205 (MCS8 to MCS15, MCS11 to MCS15 or MCS8 to MCS14) and the previous determined MCS5, MCS5 is determined as the optimum MCS according to the quality of the transmitted signals at the receiver. Following step 207, since the updated optimum MCS is the previous determined MCS, step 208 is executed, MCS5 is set as the MCS of the double antenna system 300, and the selecting method is finished.

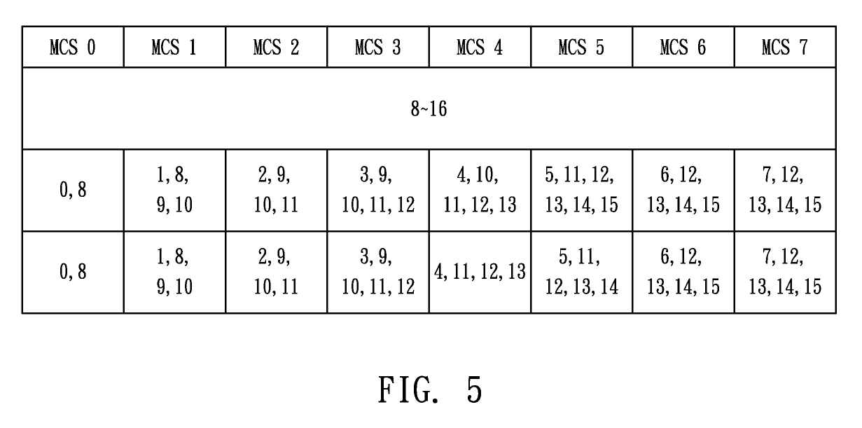

FIG. 5 shows MCS data for the double antenna system 300 including MCS values selected in step 203 from MCS0 to MCS7, and the available MCSs under selection in step 205. The first row shows all the double spatial MCSs; the second row shows the MCSs for which the data rates of the transmitted signal are between R and a×R, and a is 3; the third row shows the MCSs derived from MCS0 to MCS7 according to the experiment results shown in FIG. 1.

In conclusion, the method for selecting modulation and coding schemes for a multi-antenna system disclosed by the present invention quickly an optimum MCS according to a simple determining procedure, and is not affected by poorly established priority order or inaccurate estimated SNR and can be easily implemented.

The above-described embodiments of the present invention are intended to be illustrative only. Those skilled in the art may devise numerous alternative embodiments without departing from the scope of the following claims.

What is claimed is:

1. A method for selecting modulation and coding schemes for a multi-antenna system, comprising the steps of:
setting a dimension of transmission spatial stream signals of a multi-antenna system as 1, and transmitting signals based on different modulation and coding schemes (MCSs) to determine an initial MCS;
repeating an incrementation of the dimension of the transmission spatial stream signals by 1 and transmitting signals based on different MCSs to update the MCS of the multi-antenna system until the updated MCS is equal to an MCS before update or the dimension of the transmission spatial stream signals reaches a threshold;
selecting the MCS before update as the MCS of the multi-antenna system if the updated MCS is equal to the MCS before update; and
selecting the updated MCS as the MCS of the multi-antenna system if the dimension of the transmission spatial stream signals reaches a threshold.

2. The method of claim 1, wherein the MCS is determined according to a quality of the transmitted signals at a receiver.

3. The method of claim 1, wherein the determined MCS is an MCS with a highest data rate.

4. The method of claim 1, wherein the threshold is a maximum dimension the multi-antenna system provides.

5. The method of claim 1, wherein if the dimension of the transmission spatial stream signals of the multi-antenna system is 1, the multi-antenna system transmits signals with all MCSs of single spatial stream signals.

6. The method of claim 1, wherein if the dimension of the transmission spatial stream signals of the multi-antenna system is greater than 1, the multi-antenna system transmits signals with all MCSs of present spatial stream signals.

7. The method of claim 1, wherein if the dimension of the transmission spatial stream signals of the multi-antenna system is greater than 1, the MCSs of the transmitted signals are selected under present spatial stream signals, and data rates of the transmitted signal are between R and a×R, wherein R is the data rate of the MCS before update, and a is a positive integer.

8. The method of claim 7, wherein a is 3.

9. The method of claim 1, wherein if the dimension of the transmission spatial stream signals of the multi-antenna system is greater than 1, the MCSs of the transmitted signals are selected under present spatial stream signals and are derived from the MCS before update according to experiment data.

10. The method of claim 9, wherein the experiment data records optimum MCSs for different SNRs.

11. A method for selecting modulation and coding schemes for a multi-antenna system, comprising the steps of:
setting a dimension of transmission spatial stream signals of a multi-antenna system as 1, and transmitting signals based on different MCSs to determine an initial MCS;
repeating an incrementation of the dimension of the transmission spatial stream signals by 1 and transmitting signals based on different MCSs to update an MCS of the multi-antenna system until a data rate of the multi-antenna system is smaller than that of the multi-antenna system before update or the dimension of the transmission spatial stream signals reaches a threshold;
selecting an MCS before update as the MCS of the multi-antenna system if the data rate of the multi-antenna system is smaller than that of the multi-antenna system before update; and
selecting the updated MCS as the MCS of the multi-antenna system if the data rate of the multi-antenna system is greater than that of the multi-antenna system before update and the dimension of the transmission spatial stream signals reaches a threshold.

12. The method of claim 11, wherein the MCS is determined according to the a quality of the transmitted signals at a receiver.

13. The method of claim 11, wherein the determined MCS is an MCS with a highest data rate.

14. The method of claim 11, wherein the threshold is a maximum dimension the multi-antenna system provides.

15. The method of claim 11, wherein if the dimension of the transmission spatial stream signals of the multi-antenna system is 1, the multi-antenna system transmits signals with all MCSs of single spatial stream signals.

16. The method of claim 11, wherein if the dimension of the transmission spatial stream signals of the multi-antenna system is greater than 1, the multi-antenna system transmits signals with all MCSs of present spatial stream signals.

17. The method of claim 11, wherein if the dimension of the transmission spatial stream signals of the multi-antenna system is greater than 1, the MCSs of the transmitted signals are selected under present spatial stream signals and the data rates of the transmitted signal are between R and a×R, wherein R is the data rate of the MCS before update, and a is a positive integer.

18. The method of claim 17, wherein a is 3.

19. The method of claim 11, wherein if the dimension of the transmission spatial stream signals of the multi-antenna system is greater than 1, the MCSs of the transmitted signals are selected under present spatial stream signals and are derived from the MCS before update according to experiment data.

20. The method of claim 19, wherein the experiment data records optimum MCSs for different SNRs.
